(19) United States
(12) Patent Application Publication
(10) Pub. No.: US 2005/0276361 A1
(43) Pub. Date: Dec. 15, 2005

(54) Interference power measurement apparatus and method for space-time beam forming

(75) Inventors: Byoung-Yun Kim, Suwon-si (KR); Song-Hun Kim, Suwon-si (KR); Do-Young Kim, Seoul (KR); Jin-Weon Chang, Suwon-si (KR); Jin-Seok Lee, Seongnam-si (KR); Peter Jung, Duisburg (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/149,552

(22) Filed: Jun. 10, 2005

(30) Foreign Application Priority Data
Jun. 10, 2004 (KR) 2004-42746

(51) Int. Cl. H04L 1/02

(52) U.S. Cl. 375/347

(57) ABSTRACT

A noise and interference power measurement apparatus for an antenna diversity system that services a plurality of users with an array antenna having a plurality of antenna elements. A channel estimator estimates a channel impulse response for a radio channel corresponding to a predetermined plurality of regularly spaced direction-of-arrival (DOA) values. A data estimator estimates the received data using a received signal and a system matrix. A quantizer quantizes the estimated data. An interference and noise calculator calculates noise vectors at the respective antenna elements by removing from the received signal an influence of the quantized data to which the system matrix is applied, calculates an estimated noise matrix at the plurality of antenna elements, calculates interference power by auto-correlating the estimated noise matrix, and calculates noise and interference power based on the interference power.

### PRIORITY

This application claims the benefit under 35 U.S.C. §119(a) of an application entitled “Interference Power Measurement Apparatus and Method for Space-Time Beam Forming” filed in the Korean Intellectual Property Office on Jun. 10, 2004 and assigned Serial No. 2004-42746, the entire contents of which are incorporated herein by reference.

### BACKGROUND OF THE INVENTION

1. Field of the Invention

The present invention relates generally to an array antenna system. In particular, the present invention relates to an apparatus and method for measuring the interference power required for the calculation of spatial noise and interference power for optimal beam forming in order to transmit and receive high-speed data at high quality in the array antenna system.

2. Description of the Related Art

The reception quality of radio signals is affected by many natural phenomena. One natural phenomenon is temporal dispersion caused by signals reflected off of obstacles in different positions in a propagation path before the signals arrive at a receiver. With the introduction of digital coding in a wireless system, a temporal dispersion signal can be successfully restored using a Rake receiver or equalizer.

Another phenomenon called fast fading or Rayleigh fading, which is spatial dispersion caused by signals that are dispersed in a propagation path by an object located a short distance from a transmitter or a receiver. If the signals received through different spaces, such as spatial signals, are combined in an inappropriate phase region, the sum of the received signals has a very low intensity, approaching zero. This causes fading dips where the received signals substantially disappear, and the fading dip occurs as frequently as a length corresponding to a wavelength.

A known method of removing fading is to provide an antenna diversity system to a receiver. The antenna diversity system typically includes two or more spatially separated reception antennas. Signals received by the respective antennas have low relation to one another with respect to fading, thereby reducing the possibility that the two antennas will simultaneously generate the fading dips.

Another phenomenon that significantly affects radio transmission is interference. Interference is defined as an undesired signal received on a desired signal channel. In a cellular radio system, interference is directly related to a requirement of communication capacity. Because radio spectrum is a limited resource, a radio frequency band given to a cellular operator should be efficiently used.

Due to increasing use of cellular systems and their deployment over increasing numbers of geographic locations, research is being conducted on an array antenna geometry connected to a beam former (BF) as a new scheme for increasing traffic capacity by removing any influences of interference and fading. Each antenna element forms a set of antenna beams. A signal transmitted from a transmitter is received by each of the antenna beams, and spatial signals experiencing different spatial channels are maintained by individual angular information. The angular information is determined according to a phase difference between different signals. Direction estimation of a signal source is achieved by demodulating a received signal. The direction of a signal source is also called the “Direction of Arrival (DOA).”

Estimation of DOAs is used to select an antenna beam for signal transmission in a desired direction or to steer an antenna beam in a direction where a desired signal is received. A beam former estimates the steering vectors and DOAs for simultaneously detected multiple spatial signals, and determines beam-forming weight vectors from a set of the steering vectors. The beam-forming weight vectors are used for restoring signals. Algorithms used for beam forming include Multiple Signal Classification (MUSIC), Estimation of Signal Parameters via Rotational Invariance Techniques (ESPRIT), Weighted Subspace Fitting (WSF), and Method of Direction Estimation (MODE).

An adaptive beam forming process depends on precise knowledge of the spatial channels. Therefore, adaptive beam forming can generally only be accomplished after estimation of the spatial channels. This estimation is achieved through calculation of interference and noise power for a space from a transmitter and a receiver. A known approach for estimation of noise power is to use forward error correction (FEC) decoding. This method estimates the influence of interference by re-encoding previously detected and decoded data in the form of a reception signal matrix, and comparing the signal matrix with a currently received signal.

Disadvantageously, however, the interference power measurement using FEC decoding increases structural complexity of a receiver and causes a considerable estimation delay. Because of the estimation delay, a receiver in the conventional array antenna system is limited to a low moving velocity and a Doppler level, and thus is restricted to a system that performs FEC decoding.

### SUMMARY OF THE INVENTION

It is, therefore, an object of the present invention to provide an apparatus and method for measuring interference power using information received such that it can be directly used at a receiver through demodulation and equalization, instead of using FEC decoding.

It is another object of the present invention to provide an apparatus and method for measuring interference power required for estimation of a radio channel for beam forming in an array antenna system.

It is a further object of the present invention to provide a beam forming apparatus and method capable of reducing the implementation complexity and efficiently using spatial diversity in a Time Domain Duplex (TDD) system like a Time Division Synchronous Code Division Multiple Access (TD-SCDMA) system.

According to one aspect of the present invention, there is provided a noise and interference power measurement apparatus for an antenna diversity system that services a plurality of users with an array antenna having a plurality of antenna elements. The apparatus comprises a channel estimator for estimating a channel impulse response for a radio channel corresponding to a predetermined plurality of regularly spaced direction-of-arrival (DOA) values; a data estimator for estimating received data using a received signal and a system matrix comprising an allocated spreading code and the channel impulse response; a quantizer for quantizing the estimated data; and an interference and noise calculator for calculating noise vectors at the respective antenna elements by removing from the received signal an influence of the quantized data to which the system matrix is applied, calculating an estimated noise matrix at the plurality of antenna elements, wherein the estimated noise matrix includes the noise vectors. The interference and noise calculator calculates the interference power by auto-correlating the estimated noise matrix, and calculates the noise power based on the calculated interference power.

According to another aspect of the present invention, there is provided a noise and interference power measurement method for an antenna diversity system that services a plurality of users with an array antenna having a plurality of antenna elements. The method comprises the steps of estimating a channel impulse response for a radio channel corresponding to a predetermined plurality of regularly spaced direction-of-arrival (DOA) values; estimating received data using a received signal and a system matrix including an allocated spreading code and the channel impulse response; quantizing the estimated data; calculating noise vectors at the respective antenna elements by removing from the received signal an influence of the quantized data to which the system matrix is applied; calculating an estimated noise matrix at the plurality of antenna elements, the estimated noise matrix including the noise vectors, and calculating interference power by auto-correlating the estimated noise matrix; and calculating noise power based on the calculated interference power.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates an example of a base station with an array antenna, which communicates with a plurality of mobile stations according to an embodiment of the present invention;

FIG. 2 is a polar plot illustrating spatial characteristics of beam forming for selecting a signal from one user according to an embodiment of the present invention;

FIG. 3 is a block diagram illustrating a structure of a receiver in an array antenna system according to an embodiment of the present invention;

FIG. 4 is a block diagram illustrating a structure of a receiver in an array antenna system according to another embodiment of the present invention; and

FIG. 5 is a flowchart illustrating a method for performing an interference power measurement operation according to an embodiment of the present invention.

### DETAILED DESCRIPTION OF EXEMPLARY EMBODIMENTS

Exemplary embodiments of the present invention will now be described in detail with reference to the accompanying drawings. In the following description, a detailed description of known functions and configurations incorporated herein has been omitted for the sake of clarity and conciseness.

Embodiments of the present invention described below determine interference power without using forward error correction (FEC) decoding, in performing beam forming by estimating a spatial channel in an antenna diversity system. Specifically, an exemplary embodiment of the present invention reduces both the estimation delay and implementation complexity using the information that can be directly used at a receiver after a modulation and equation process, instead of using the FEC decoding.

For estimation of spatial channels, a reception side requires the arrangement of an array antenna having Kₐ antenna elements. Such an array antenna serves as a spatial low-pass filter having a finite spatial resolution. The term “spatial low-pass filtering” refers to an operation of dividing an incident wave (or impinging wave) of an array antenna into spatial signals that pass through different spatial regions. A receiver having the foregoing array antenna combines a finite number, N_{b}, of spatial signals, through beam forming. As described above, the optimal beam forming requires information on DOAs and a temporal dispersion channel's impulse response for the DOAs. A value of the N_{b} cannot be greater than a value of the Kₐ, and thus represents the number of resolvable spatial signals. The maximum value, max(N_{b}), of the N_{b} is fixed according to a geometry of the array antenna.

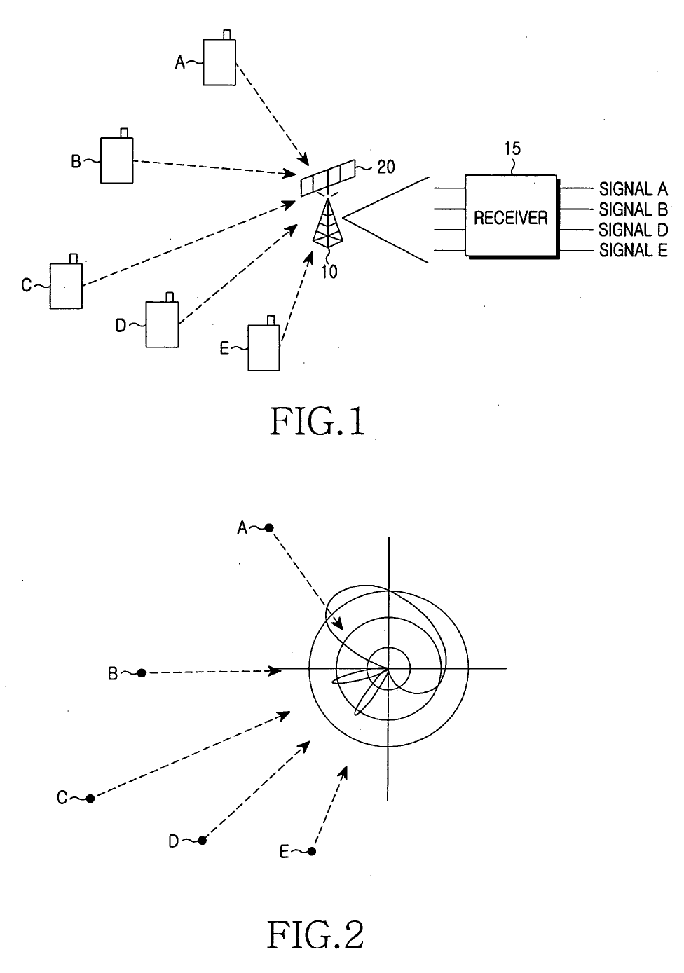

FIG. 1 illustrates an example of a base station (or a Node B) with an array antenna, which communicates with a plurality of mobile stations (or user equipments). Referring to FIG. 1, a base station 10 has an array antenna 20 comprised of 4 antenna elements. The base station 10 has 5 users A, B, C, D and E located in its coverage area. A receiver 15 selects signals from desired users from among the 5 users, by beam forming. Because the array antenna 20 of FIG. 1 has only 4 antenna elements, the receiver 15 restores signals from a maximum of 4 users, in this case, signals from users A, B, D and E as illustrated, by beam forming.

FIG. 2 illustrates spatial characteristics of beam forming for selecting a signal from a user A, by way of example. As illustrated, a very high weight, or gain, is applied to a signal from a user A, while a gain approximating zero is applied to the signals from the other users, B through E.

A system model applied to an exemplary embodiment of the present invention will now be described.

A burst transmission frame of a radio communication system has bursts including two data carrying parts (also known as sub-frames or a half burst) each comprised of N data symbols. Mid-ambles which are training sequences predefined between a transmitter and a receiver, having Lₘ chips, are included in each data carrying part so that the channel characteristics and interferences in a radio section can be measured. The radio communication system supports multiple access based on Transmit Diversity Code Division Multiple Access (TD-CDMA), and spreads each data symbol using a Q-chip Orthogonal Variable Spreading Factor (OVSF) code, which is a user-specific CDMA code. In a radio environment, there are K users per cell and frequency band, and per time slot. As a whole, there are Kᵢ inter-cell interferences.

A base station (or a Node B) uses an array antenna having Kₐ antenna elements. Assuming that a signal transmitted by a k^{th} user (k=1, . . . , K) is incident upon (impinges on) the array antenna in k_{d}^{(d)} different directions, each of the directions is represented by a cardinal identifier k_{d} (k_{d}=1, . . . , K_{d}^{(d)}). Then, a phase factor of a k_{d}^{th} spatial signal which is incident upon the array antenna from a k^{th} user (i.e., a user #k) through a kₐ^{th} antenna element (such that an antenna element kₐ (kₐ=1, . . . , Kₐ)) is defined as

$$Ψ ( k , {k}_{a} , {k}_{d} ) = 2 π \frac{{l}^{( {k}_{a} )}}{λ} \cdot cos ( {β}^{( k , {k}_{d} )} - {α}^{( {k}_{a} )} ) , \\ k = 1 … K , {k}_{a} = 1 … {K}_{a} , {k}_{d} = 1 … {K}_{d}^{( k )} \qquad Equation ( 1 )$$

In Equation (1), α^{(k}^{ₐ}⁾ denotes an angle between a virtual line connecting antenna elements arranged with a predetermined distance from each other to a predetermined antenna array reference point and a predetermined reference line passing through the antenna array reference point, and its value is previously known to a receiver according to the geometry of the array antenna. In addition, β^{(k,k}^{_{d}}⁾ denotes a DOA in radians, representing a direction of a k_{d}^{th} spatial signal arriving from a user #k on the basis of the reference line, λ denotes a wavelength of a carrier frequency, and l^{(k}^{ₐ}⁾ denotes a distance between a kₐ^{th} antenna element and the antenna array reference point.

For each DOA β^{(k,k}^{_{d}}⁾ of a desired signal associated with a user #k, a unique channel impulse response observable by a virtual unidirectional antenna located in the reference point is expressed by a directional channel impulse response vector of Equation (2) below representing W path channels.
h_{d}^{(k,k}^{_{d}}⁾=(h_{d,1}^{(k,k}^{_{d}}⁾,h_{d,2}^{(k,k}^{_{d}}⁾, . . . ,h_{d,W}^{(k,k}^{_{d}}⁾, k=1 . . . K,k_{d}=1 . . . K_{d}^{(k)} Equation (2)
where a superscript ‘T’ denotes transpose of a matrix or a vector, and an underline indicates a matrix or a vector.

For each antenna element kₐ, W path channels associated with each of a total of K users are measured. Using Equation (1) and Equation (2), it is possible to calculate a discrete-time channel impulse response vector representative of a channel characteristic for an antenna kₐ for a user #k as shown in Equation (3).

$$\begin{matrix}{\underline{h}}^{( k , {k}_{a} )} = {( {\underline{h}}_{1}^{( k , {k}_{a} )} , {\underline{h}}_{2}^{( k , {k}_{a} )} , … , {\underline{h}}_{W}^{( k , {k}_{a} )} )}^{T} \\ = {\sum }_{{k}_{d} = 1}^{{K}_{d}^{k}} exp \{ jΨ ( k , {k}_{a} , {k}_{d} ) \} \cdot {\underline{h}}_{d}^{( k , {k}_{d} )} ,\end{matrix} \\ k = 1 … K , {k}_{a} = 1 … {K}_{a} \qquad Equation ( 3 )$$

In Equation (3), h^{(k,k}^{_{d}}⁾ denotes a vector representing a discrete-time channel impulse response characteristic for a k_{d}^{th} spatial direction, from a user #k. Herein, the vector indicates that the channel impulse response characteristic includes directional channel impulse response characteristics h₁^{(k,k}^{_{d}}⁾,h₂^{(k,k}^{_{d}}⁾, . . . ,h_{W}^{(k,k}^{_{d}}⁾ for W spatial channels. The directional channel impulse response characteristics are associated with the DOAs illustrated in Equation (1).

Using a directional channel impulse response vector of Equation (5) below that uses a W×(W·K_{d}^{(k)}) phase matrix illustrated in Equation (4) below including a phase factor Ψ associated with a user #k and an antenna element kₐ and includes all directional impulse response vectors associated with the user #k, Equation (3) is rewritten as Equation (6).
Aₛ^{(k,k}^{ₐ}⁾=(e^{jΨ(k,k}^{ₐ}^{,1)}I_{w},e^{jΨ(k,k}^{ₐ}^{,2)}I_{W}, . . . ,e^{jΨ(k,k}^{ₐ}^{,K}^{_{d}}^{^{(k)}}⁾I_{W}), k=1 . . . K,kₐ=1 . . . Kₐ Equation (4)
where Aₛ^{(k,k}^{ₐ}⁾ denotes a phase vector for K_{d}^{(d)} directions of a user #k, and I_{w} denotes a W×W identity matrix.
h_{d}^{(k)}=(h_{d}^{(k,1)T},h_{d}^{(k,2)T}, . . . ,h_{d}^{(k,K}^{_{d}}^{^{(k)}}^{)T})^{T}, k=1 . . . K Equation (5)
h^{(k,k}^{ₐ}⁾=Aₛ^{(k,k}^{ₐ}⁾h_{d}^{(k)}, k=1 . . . K,kₐ=1 . . . Kₐ Equation (6)

Using a channel impulse response of Equation (6) associated with a user #k, a channel impulse response vector comprised of K·W elements for an antenna element kₐ for all of K users is written as
h^{(k}^{ₐ}⁾=((Aₛ^{(1,k}^{ₐ}⁾h_{d}⁽¹⁾)^{T},(Aₛ^{(2,k}^{ₐ}⁾h_{d}⁽²⁾)^{T}, . . . ,(Aₛ^{(K,k}^{ₐ}⁾h_{d}^{(K)})^{T})^{T}, kₐ=1 . . . Kₐ Equation (7)

A directional channel impulse response vector having K·W·K_{d}^{(k)} elements is defined as
h_{d}=(h_{d}^{(1)T},h_{d}^{(2)T}, . . . ,h_{d}^{(K)T})^{T} Equation (8)
where h_{d}^{(k)} denotes a directional channel impulse response vector for a user #k.

Equation (9) below expresses a phase matrix Aₛ^{(k}^{ₐ}⁾ for all of K users for an antenna element kₐ as a set of phase matrixes for each user.

$${\underline{A}}_{s}^{( {k}_{a} )} = [ \begin{matrix}{\underline{A}}_{s}^{( 1 , {k}_{a} )} & 0 & … & 0 \\ 0 & {\underline{A}}_{s}^{( 2 , {k}_{a} )} & … & 0 \\ ⋮ & ⋮ & ⋰ & ⋮ \\ 0 & 0 & … & {\underline{A}}_{s}^{( K , {k}_{a} )}\end{matrix} ] , {k}_{a} = 1 … {K}_{a} \qquad Equation ( 9 )$$

In Equation (9), a ‘0’ denotes a W×(W·K_{d}^{(k)}) all-zero matrix, and the phase matrix Aₛ^{(k}^{ₐ}⁾ has a size of (K·W)×(K·W·K_{d}^{(k)}). Then, for Equation (7), a channel impulse response vector for all of K_{d}^{(k)} signals for all of K users at an antenna element kₐ can be calculated by
h^{(k}^{ₐ}⁾=Aₛ^{(k}^{ₐ}⁾h_{d}, kₐ=1 . . . Kₐ Equation (10)

Using Equation (10), a combined channel impulse response vector having K·W·Kₐ elements is written as
h=(h^{(1)T},h^{(2)T}, . . . ,h^{(K}^{ₐ}^{)T})^{T} Equation (11)

That is, a phase matrix Aₛ in which all of K_{d}^{(k)} spatial signals for all of the K users for all of Kₐ antenna elements are taken into consideration is defined as Equation (12), and a combined channel impulse response vector h is calculated by a phase matrix and a directional channel impulse response vector as shown in Equation (13).
Aₛ=Aₛ^{(1)T},Aₛ^{(2)T}, . . . ,Aₛ^{(K}^{ₐ}^{)T})^{T} Equation (12)
h=Aₛh_{d} Equation (13)

The phase matrix Aₛ, as described above, is calculated using β^{(k,k}^{_{d}}⁾ representative of DOAs for the spatial signals for each user.

The directional channel impulse response vector h_{d} includes the influence of interference power and noise. The possible number of interferences incident upon a receiver is expressed as
L=Lₘ−W+1 Equation (14)
where Lₘ denotes a length of a mid-amble as described above, and W denotes the number of path channels.

When Kᵢ interference signals having the highest power among a total of L noises are taken into consideration, if an angle to a reference line estimated for a kᵢ^{th} interference signal among the Ki interference signals is defined as an incident angle γ^{(k}^{ᵢ}⁾ of the corresponding interference signal, a phase factor of a kᵢ^{th} interference signal incident upon a kₐ^{th} antenna element is written as

$$Φ ( {k}_{i} , {k}_{a} ) = 2 π \frac{{l}^{( {k}_{a} )}}{λ} \cdot cos ( {γ}^{( {k}_{i} )} - {α}^{( {k}_{a} )} ) , \\ {k}_{i} = 1 … {K}_{i} , {k}_{a} = 1 … {K}_{a} \qquad Equation ( 15 )$$

Assuming that a reception vector associated with an interference signal kᵢ is defined as nᵢ^{(k}^{ᵢ}⁾, a noise vector n^{(k}^{ₐ}⁾ for a kₐ^{th} antenna element becomes

$${\underline{n}}^{( {k}_{a} )} = {\sum }_{{k}_{i} = 1}^{K} {ⅇ}^{jΦ ( {k}_{i} , {k}_{a} )} {\underline{n}}_{i}^{( {k}_{a} )} + {\underline{n}}_{th}^{( {k}_{a} )} , {k}_{a} = 1 … {K}_{a} \qquad Equation ( 16 )$$

In Equation (16), a vector nₜₕ^{(k}^{ₐ}⁾ denotes a thermal noise measured at an antenna element kₐ having a double-sided spectral noise density Nₒ/2, a lower-case letter ‘e’ denotes an exponential function of a natural logarithm, and N₀ denotes spectral noise density.

However, because of spectrum forming by modulation and filtering, a measured thermal noise is generally a non-white noise. The non-white noise has a thermal noise covariance matrix having a normalized temporal covariance matrix \tilde{R}ₜₕ of a colored noise as shown in Equation (17).
Rₜₕ=N₀\tilde{R}ₜₕ Equation (17)

In Equation (17), ‘~ (tilde)’ means an estimated value, and a description thereof will be omitted herein for convenience.

If a Kronecker symbol shown in Equation (18) below is used, an L×L covariance matrix Rₙ^{(u,v)} meaning noise power between an u^{th} antenna element and a v^{th} antenna element is written as Equation (19). Herein, u and v each are a natural number between 1 and Kₐ.

$$\begin{matrix}{δ}_{uv} = \{ \begin{matrix}1 & u = v \\ 0 & else\end{matrix} & Equation ( 18 ) \\ \begin{matrix}{\underline{R}}_{n}^{( u , v )} = E \{ {\underline{n}}^{( u )} {\underline{n}}^{( v ) H} \} \\ = E \{ ( {\sum }_{{k}_{i} = 1}^{{K}_{i}} {ⅇ}^{jΦ ( {k}_{i} , u )} {\underline{n}}_{i}^{( {k}_{i} )} {\underline{n}}_{th}^{( u )} ) \\ {( {\sum }_{{k}_{i} = 1}^{{K}_{i}} {ⅇ}^{jΦ ( {k}_{i} , v )} {\underline{n}}_{i}^{( {k}_{i} )} + {\underline{n}}_{th}^{( v )} )}^{H} \} \\ = E \{ ( {\sum }_{{k}_{i} = 1}^{{K}_{i}} {ⅇ}^{jΦ ( {k}_{i} , u ) - jΦ ( {k}_{i} , v )} {\underline{n}}_{i}^{( {k}_{i} )} {\underline{n}}_{i}^{( {k}_{i} ) H} ) \} + \\ E \{ {\underline{n}}_{th}^{( u )} {\underline{n}}_{th}^{( v ) H} \} \\ = {\sum }_{{k}_{i} = 1}^{{K}_{i}} {ⅇ}^{jΦ ( {k}_{i} , u ) - jΦ ( {k}_{i} , v )} E \{ {\underline{n}}_{i}^{( {k}_{i} )} {\underline{n}}_{i}^{( {k}_{i} ) H} \} + \\ {δ}_{uv} {N}_{0} {\tilde{\underline{R}}}_{th} , u , v = 1 … {K}_{a}\end{matrix} & Equation ( 19 )\end{matrix}$$

In Equation (19), E{•} denotes a function for calculating energy, and a superscript ‘H’ denotes a Hermitian transform of a matrix or a vector. Assuming in Equation (19) that interference signals of different antenna elements have no spatial correlation and there is no correlation between the interferences and thermal noises, Equation (20) is given. Therefore, in accordance with Equation (20), the energy of a kᵢ^{th} interference signal can be calculated using the power of the kᵢ^{th} interference signal.
E{nᵢ^{(k}^{ᵢ}⁾nᵢ^{(k}^{ᵢ}^{)H}}=(σ^{(k}^{ᵢ}⁾)²·\tilde{R} Equation (20)

In Equation (20), {σ^{(k}^{ᵢ}⁾)² denotes the power of a kᵢ^{th} interference signal. The L×L normalized temporal covariance matrix \tilde{R} is constant for all of Kᵢ interferences and represents a spectral form of an interference signal, and its value is known to a receiver. The \tilde{R} is a matrix indicating a correlation value between one interference signal and another interference signal, for each of the interference signals. The correlations are determined according to whether the relationships between the interference signals are independent or dependent. If there is high probability that when one interference signal A occurs another interference signal B will occur, a correlation between the two interference signals is high. In contrast, if there is no relation between the generation of the two interference signals, a correlation between the two interference signals is low. Therefore, if there is no correlation between interference signals, in other words, if the interference signals are independent, \tilde{R} has a form of a unit matrix in which all elements except the diagonal elements are 0s. That is, \tilde{R}ₜₕ and \tilde{R} are approximately equal to each other as shown in Equation (21) below.
\tilde{R}≈\tilde{R}ₜₕ≈I_{L} Equation (21)

In Equation (21), I_{L} denotes an L×L identity matrix. Thus, Equation (19) can be simplified as

$$\begin{matrix}{\underline{R}}_{n}^{( u , v )} = \tilde{\underline{R}} \cdot {\sum }_{{k}_{i} = 1}^{{K}_{i}} {( {σ}^{( {k}_{i} )} )}^{2} {ⅇ}^{jΦ ( {k}_{i} , u ) - jΦ ( {k}_{i} , v )} + {δ}_{uv} {N}_{0} {\tilde{\underline{R}}}_{th} \\ = {\underline{r}}_{u , v} \tilde{\underline{R}} + {δ}_{uv} {N}_{0} {\tilde{\underline{R}}}_{th} \\ \approx ( {\underline{r}}_{u , v} + {δ}_{uv} {N}_{0} ) {I}_{L} , u , v = 1 … {K}_{a}\end{matrix} \qquad Equation ( 22 )$$

A vector r_{u,v} is an interference signal between an antenna element ‘u’ and an antenna element ‘v’, defined by Equation (22) itself.

Using Equation (22), an LKₐ×LKₐ covariance matrix of a combined noise vector n defined in Equation (15) is expressed as

$$\begin{matrix}{\underline{R}}_{n} = [ \begin{matrix}{\underline{r}}_{1 , 1} & {\underline{r}}_{1 , 2} & … & {\underline{r}}_{1 , {K}_{a}} \\ {\underline{r}}_{2 , 1} & {\underline{r}}_{2 , 2} & … & {\underline{r}}_{2 , {K}_{a}} \\ ⋮ & ⋮ & ⋰ & ⋮ \\ {\underline{r}}_{{K}_{a} , 1} & {\underline{r}}_{{K}_{a} , 2} & … & {\underline{r}}_{{K}_{a} , {K}_{a}}\end{matrix} ] ⊗ \tilde{\underline{R}} + {N}_{0} {I}_{{K}_{a}} ⊗ {\tilde{\underline{R}}}_{th} \\ = {\underline{R}}_{DOA} ⊗ \tilde{\underline{R}} + {N}_{0} {I}_{{K}_{a}} ⊗ {\tilde{\underline{R}}}_{th} \\ \approx [ {\underline{R}}_{DOA} + {N}_{0} {I}_{{K}_{a}} ] ⊗ \tilde{\underline{R}} \\ \approx [ {\underline{R}}_{DOA} + {N}_{0} {I}_{{K}_{a}} ] ⊗ {I}_{L}\end{matrix} \qquad Equation ( 23 )$$

In Equation (23), a matrix R_{DOA} denotes interference power, and is defined by Equation (23) itself. The matrix R_{DOA}, as it is substantially equal to the vector r_{u,v}, becomes a Hermitian matrix in which the diagonal elements are equal to each other. Therefore, if only the upper and lower triangular elements of the R_{DOA} matrix are estimated, all of the remaining elements can be determined.

According to Equation (22) and Equation (23), it is noted that a Kₐ×Kₐ matrix R_{DOA} is related only to DOAs and the interference power of Kᵢ interferences. Assuming that there is no spatial correlation between the interference signals of the different antenna elements, because the interference signals between the different antenna elements become 0, the R_{DOA} can be determined using only the kᵢ^{th} interference power {σ^{(k}^{ᵢ}⁾)² and the spectral noise density N₀, and the overall noise power Rₙ is calculated by the R_{DOA}.

Such beam forming comprises a first step of measuring noise and interference power that indicate an influence of noises and interferences, a second step of measuring a spatial and temporal channel impulse response using the measured noise and interference power, and a third step of calculating steering vectors based on the estimated channel impulse response and performing beam forming using the channel impulse response and the steering vectors for an estimated DOA of an incident wave.

Estimation of DOAs is one of the important factors covering one of a plurality of steps performed to acquire a desired signal. A receiver evaluates signal characteristics for all directions of 0 to 360°, and regards a direction having a peak value as a DOA. Because this process requires so many calculations, research is being performed on several schemes for simplifying the DOA estimation. However, even though the receiver achieves correct DOA estimation, it is difficult to form a beam that correctly receives only the incident wave for a corresponding DOA according to the estimated DOA. Further, in order to accurately estimate DOAs, many calculations are required.

Therefore, an embodiment of the present invention replaces the irregular spatial sampling with a regular sampling technique and uses several predetermined fixed values instead of estimating DOAs in a beam forming process.

An array antenna that forms beams in several directions represented by DOAs can be construed as a spatial low-pass filter that passes only the signals of a corresponding direction. The minimum spatial sampling frequency is given by the maximum spatial bandwidth B of a beam former. For a single unidirectional antenna, B=1/(2π).

If a spatially periodic low-pass filtering characteristic is taken into consideration using given DOAs, regular spatial sampling with a finite number of spatial samples is possible. Essentially, the number of DOAs, representing the number of spatial samples, such as the number of resolvable beams, is given by a fixed value N_{b}. Selection of the N_{b} depends upon the array geometry. In the case of a Uniform Circular Array (UCA) antenna where antenna elements are arranged on a circular basis, the N_{b} is selected such that it should be equal to the number of antenna elements. In the case of another array geometry, for example, an Uniform Linear Array (ULA), the N_{b} is determined by Equation (24) so that the maximum spatial bandwidth possible that is determined for all possible scenarios can be taken into consideration.
N_{b}=┌2πB┐ Equation (24)

In Equation (24), ‘┌x┐’ denotes the maximum integer not exceeding a value “x”. For example, assuming that the possible maximum spatial bandwidth is B=12/(2π), there are N_{b}=12 beams.

In the case where the number of directions, K_{d}^{(k)} (k=1, . . . , K), is fixed and the regular spatial sampling is implemented according to an embodiment of the present invention, the number K_{d}^{(k)} of directions is equal to the number N_{b} of DOAs. Accordingly, in the receiver, a wave transmitted by a user #k affects the antenna array in the N_{b} different directions. As described above, each direction is represented by the cardinal identifier k_{d} (k_{d}=1, . . . , N_{b}), and angles β^{(k,k}^{_{d}}⁾ associated with DOAs are taken from a finite set B defined as

$$B = \{ {β}_{0} , {β}_{0} + \frac{2 π}{{N}_{b}} , {β}_{0} + 2 \frac{2 π}{{N}_{b}} , … , {β}_{0} + ( {N}_{b} - 1 ) \frac{2 π}{{N}_{b}} \} \qquad Equation ( 25 )$$

In Equation (25), βₒ denotes a randomly-selected fixed zero phase angle, and is preferably set to a value between 0 and π/N_{b} [radian]. In the foregoing example where N_{b}=12 beams and βₒ=0 are used, Equation (25) calculates Equation (26) below corresponding to a set of angles including 0°, 30°, 60°, . . . , 330°.

$$B = \{ 0 , \frac{π}{6} , 2 \frac{π}{6} , … , 11 \frac{π}{6} \} \qquad Equation ( 26 )$$

When the set B of Equation (26) is selected, the possible different values of β^{(k,k}^{_{d}}⁾ are the same for all users k=1, . . . , K. The values are previously known to the receiver. Therefore, the receiver no longer requires the DOA estimation.

Assuming that there are Kᵢ=N_{b} interferences, implementation of angle domain sampling will be described in more detail below. Because all of the possible values of Equation (26) are acquired by angles β^{(k,k}^{_{d}}⁾ of incident signals and angles γ^{(k}^{ᵢ}⁾ of interference signals, the β^{(k,k}^{_{d}}⁾ and γ^{(k}^{ᵢ}⁾ are selected by Equation (27) and Equation (28), respectively.

$$\begin{matrix}{β}^{( k , {k}_{d} )} = {β}^{( {k}_{d} )} = {β}_{0} + 2 \frac{π}{{N}_{b}} ( {k}_{d} - 1 ) , \\ k = 1 … K , {k}_{d} = 1 … {N}_{b} & Equation ( 27 ) \\ {γ}^{( {k}_{i} )} = {β}_{0} + 2 \frac{π}{{N}_{b}} ( {k}_{i} - 1 ) , {k}_{i} = 1 … {N}_{b} & Equation ( 28 )\end{matrix}$$

From the β^{(k,k}^{_{d}}⁾ and γ^{(k}^{ᵢ}⁾, a phase factor of a k_{d}^{th} spatial signal, which is incident upon a kₐ^{th} antenna element (kₐ=1, . . . , Kₐ) from a k^{th} user, and a phase factor of a kᵢ^{th} interference signal, which is incident upon the kₐ^{th} antenna element, are calculated by Equation (29).

$$Ψ ( k , {k}_{a} , {k}_{d} ) = Ψ ( {k}_{a} , {k}_{d} ) = 2 π \frac{{l}^{( {k}_{a} )}}{λ} \cdot cos ( {β}^{( {k}_{d} )} - {α}^{( {k}_{a} )} ) , \\ Φ ( {k}_{i} , {k}_{a} ) = Φ ( {k}_{d} , {k}_{a} ) = 2 π \frac{{l}^{( {k}_{a} )}}{λ} \cdot cos ( {γ}^{( {k}_{d} )} - {α}^{( {k}_{a} )} ) , \\ {k}_{i} = {k}_{d} = 1 … {N}_{b} , {k}_{a} = 1 … {K}_{a} , k = 1 … K \qquad Equation ( 29 )$$

Herein, an angle α^{(k}^{ₐ}⁾ and a distance l^{(k}^{ₐ}⁾ are fixed by the geometry of the array antenna.

The number of columns in the phase vector Aₛ defined in Equation (12) is K·W·K_{d}^{(k)}. However, if Equation (25) and Equation (29) are used, the number of columns is fixed, thereby simplifying the signal processing.

Another important factor that should be performed for beam forming is estimation of the interference power R_{DOA}. For the estimation of the interference power, the typical system requires a difference signal between a previously received signal and a currently received signal. However, this requires a reconfiguration process for the data detected after being received, thereby increasing the structural complexity of the receiver.

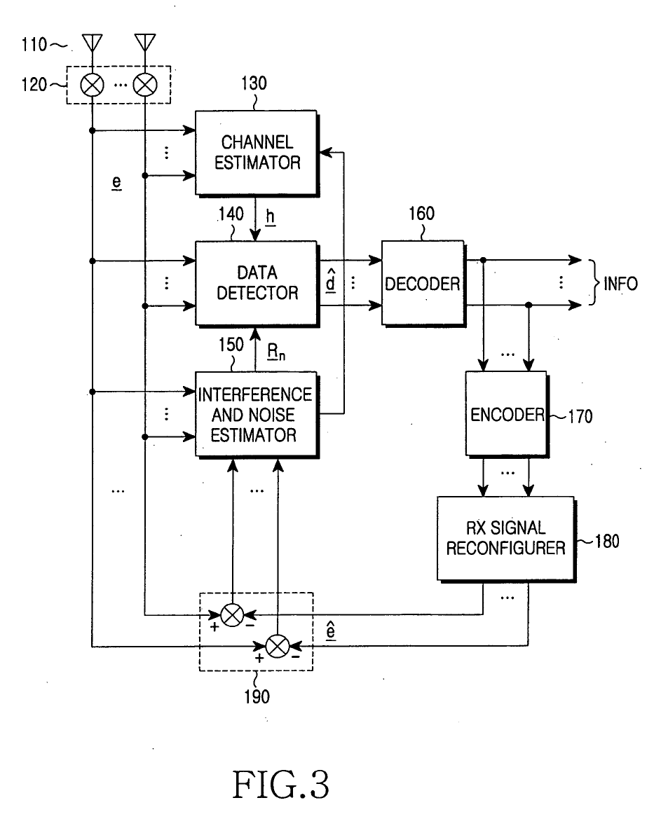

FIG. 3 is a block diagram illustrating a structure of a receiver in an array antenna system according to an embodiment of the present invention. Referring to FIG. 3, an antenna 110 is an array antenna having antenna elements in a predetermined geometry, and receives a plurality of spatial signals which are incident thereupon through spaces. Each of the multipliers 120 multiplies an output of its associated antenna element by a weight vector determined by a beam forming operation. The received signals including the weight vector are provided in common to a channel estimator 130, a data detector 140, and an interference and noise estimator 150.

The interference and noise estimator 150 first sets interference and noise power to an initial value, and henceforth, measures interference and noise power using a difference signal between a previous reception signal and a current reception signal, provided from a difference signal generator 190. The channel estimator 130 calculates a spatial and temporal channel impulse response matrix using the interference and noise power. The data detector 140 detects data from the current reception signal using the spatial and temporal channel impulse response matrix and the interference and noise power, and the detected data is subject to error correction and decoding by a decoder 160.

The decoded data is encoded again by an encoder 170, to be used for interference and noise estimation. A reception signal reconfigurer 180 reconfigures the previous reception signal using the coded data, and provides the reconfigured previous reception signal to the difference signal generator 190 such that it can be compared with the current reception signal. In this way, the interference and noise estimator 150 compares the previous reception signal subjected to FEC decoding with the current reception signal, and uses the comparison result for estimation of interference power.

However, the encoding and reception signal reconfiguration process increases structural complexity of the receiver and causes a delay in the estimation of the interference power. In the following description, therefore, an exemplary embodiment of the present invention provides a simpler algorithm to reduce the implementation complexity of the process.

A description will now be made of a least square beam forming process according to an embodiment of the present invention. A joint transmission paradigm considered in an embodiment of the present invention will first be described in detail with mathematical expressions.

As described above, the number of data symbols in a half burst and the number of OVSF code chips per data symbol will be denoted by N and Q, respectively. If the number of users is defined as K, a combined data vector having K·N data symbols is denoted by d. Assuming that spreading by an OVSF code and passing through a radio channel are represented by a system matrix A, a reception vector is given as
e=Ad+n Equation (30)

The system matrix is expressed as Equation (31) using an OVSF code C^{(k)} allocated to a user #k and a channel impulse response matrix h^{(k)} for the user #k.
A^{(k)}=h^{(k)}C^{(k)} Equation (31)

In the case of an unknown R_{DOA}, a data vector can be estimated through Equation (32) using a known spatio-temporal zero forcing block linear equalizer (ZF-BLE) method for joint detection of transmitted data.
\hat{d}≈[A^{H}(I_{K}_{ₐ}\mathring{x}\tilde{R}⁻¹)A]⁻¹A^{H}(I_{K}_{ₐ}\mathring{x}\tilde{R}⁻¹)e Equation (32)

In Equation (32), \tilde{R} is a value previously known to the receiver, and I_{K}_{ₐ} is a Kₐ×Kₐ identity matrix. In the case of a low bit error rate (BER), a quantized version Q{\hat{d}} of the data vector is equal to a true data vector, such as
\hat{d}_{q}=Q{\hat{d}} Equation (33)

A noise at the ZF-BLE is given by
n′=e−A\hat{d}_{q} Equation (34)

In order to calculate a spatial covariance matrix R_{DOA} of interferences, an expected value for the number of estimated data samples in a cell must be known. However, because the number of the estimated data samples is infinite, it is impossible to know the expected value in the actual system. Therefore, the preferred embodiment of the present invention acquires R_{DOA} from continuously received vectors.

It is assumed that an interference scenario is in a rather stationary state such that the spatial covariance matrix of interferences can be estimated. Essentially, this means that adjacent cells are rather tightly synchronized without using slot frequency hopping.

A superscript ‘z’ is added to the noise vector of Equation (34) to be distinguished from its preceding and succeeding noise vectors, and it is considered that the ‘z’ ranges from 1 to Z. The Z is preferably selected to be less than N. Then, a noise vector estimated from an antenna element kₐ (kₐ=1, . . . , Kₐ) is denoted by \hat{n}_{W}^{(K}^{ₐ}^{,z)} having preferably 2(NQ+W−1) elements. The number of data symbols in each half burst and the number of chips per data symbol are determined as N and Q, respectively. As a result, a Kₐ·Z×2(NQ+W−1) noise matrix representing Z noises at all the antenna elements is

$${\hat{\underline{N}}}_{DOA} = [ \begin{matrix}{\hat{\underline{n}}}^{( 1 , 1 ) T} & {\hat{\underline{n}}}^{( 1 , 2 ) T} & … & {\hat{\underline{n}}}^{( 1 , Z ) T} \\ {\hat{\underline{n}}}^{( 2 , 1 ) T} & {\hat{\underline{n}}}^{( 2 , 2 ) T} & … & {\hat{\underline{n}}}^{( 2 , Z ) T} \\ ⋮ & ⋮ & ⋰ & ⋮ \\ {\hat{\underline{n}}}^{( {K}_{a} , 1 ) T} & {\hat{\underline{n}}}^{( {K}_{a} , 2 ) T} & … & {\hat{\underline{n}}}^{( {K}_{a} , Z ) T}\end{matrix} ] \qquad Equation ( 35 )$$

where a superscript ‘T’ denotes transpose.

Therefore, a Kₐ×Kₐ estimated interference power matrix of Equation (36) can be yielded by normalizing an autocorrelation matrix of the noise matrix by Z.

$${\hat{\underline{R}}}_{DOA} = \frac{1}{Z} {\hat{\underline{N}}}_{DOA} {\hat{\underline{N}}}_{DOA}^{H} \\ = \frac{1}{Z} [ \begin{matrix}{\sum }_{z = 1}^{Z} {‖ {\hat{\underline{n}}}^{( 1 , z )} ‖}^{2} & {\sum }_{z = 1}^{Z} {\hat{\underline{n}}}^{( 1 , z ) H} {\hat{\underline{n}}}^{( 2 , z )} & … & {\sum }_{z = 1}^{Z} {\hat{\underline{n}}}^{( 1 , z ) H} {\hat{\underline{n}}}^{( {K}_{a} , z )} \\ {( {\sum }_{z = 1}^{Z} {\hat{\underline{n}}}^{( 1 , z ) H} {\hat{\underline{n}}}^{( 2 , z )} )}^{*} & {\sum }_{z = 1}^{Z} {‖ {\hat{\underline{n}}}^{( 2 , z )} ‖}^{2} & … & {\sum }_{z = 1}^{Z} {\hat{\underline{n}}}^{( 2 , z ) H} {\hat{\underline{n}}}^{( {K}_{a} , z )} \\ ⋮ & ⋮ & ⋰ & ⋮ \\ {( {\sum }_{z = 1}^{Z} {\hat{\underline{n}}}^{( 1 , z ) H} {\hat{\underline{n}}}^{( {K}_{a} , z )} )}^{*} & {( {\sum }_{z = 1}^{Z} {\hat{\underline{n}}}^{( 2 , z ) H} {\hat{\underline{n}}}^{( {K}_{a} , z )} )}^{*} & … & {\sum }_{z = 1}^{Z} {‖ {\hat{\underline{n}}}^{( {K}_{a} , z )} ‖}^{2}\end{matrix} ] \qquad Equation ( 36 )$$

Although there is still thermal noise, given that the noise vector used in Equation (35) is a difference between an actually received signal and an estimated data vector as shown in Equation (34), the estimated interference power calculated by Equation (36) becomes an estimated value of R_{DOA}+N₀I_{K}_{ₐ} in Equation (23), used in finding actual noise and interference power. Therefore, further estimation of the thermal noise and other factors is not required.

Because the estimated interference power of Equation (36) is a Hermitian matrix, it is needed to estimate diagonal and off-diagonal elements of an upper or lower triangular part of \hat{R}_{DOA}. The resultant \hat{R}_{DOA} must be permanently updated at an update rate that depends on a change rate of the foregoing scenario.

Once Equation (36) is calculated, an estimated noise and interference power value can be found as shown in Equation (37) by Equation (23).
\hat{R}ₙ=\hat{R}_{DOA}\mathring{x}\tilde{R} Equation (37)

In an approximately white noise environment, Equation (37) is simplified as
\hat{R}ₙ≈\hat{R}_{DOA}\mathring{x}I_{L} Equation (38)

In Equation (38), I_{L} denotes an L×L identity matrix, and the estimated interference power is extended for all of L interference signals by Equation (38).

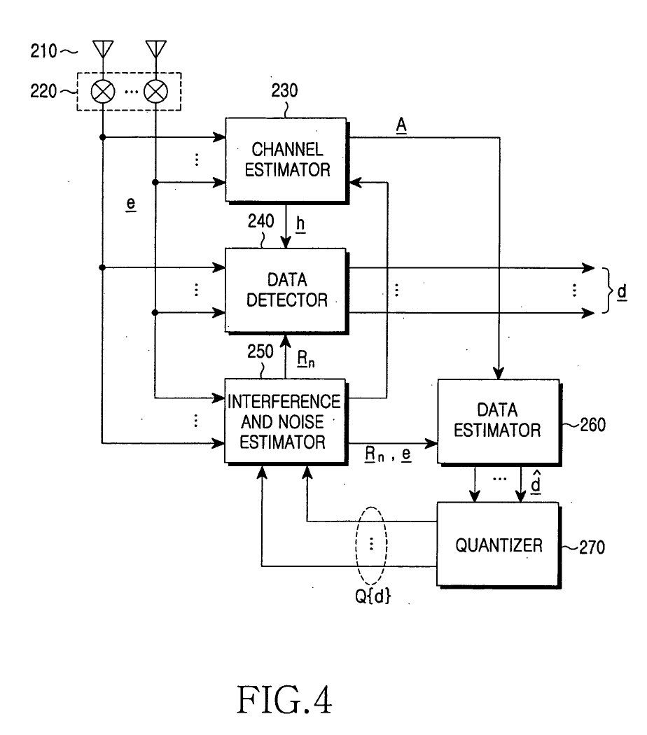

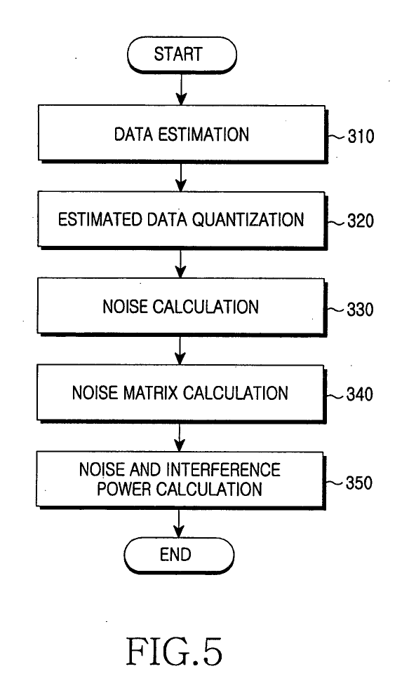

FIG. 4 is a block diagram illustrating a structure of a receiver in an array antenna system according to another embodiment of the present invention, and FIG. 5 is a flowchart illustrating an operation of calculating interference power by a data estimator 260, a quantizer 270, and an interference and noise estimator 250 in the receiver illustrated in FIG. 4.

Referring to FIG. 4, an antenna 210 is an array antenna having antenna elements in a predetermined geometry, and receives a plurality of spatial signals which are incident thereupon through space. Each of the multipliers 220 multiplies an output of its associated antenna element by a weight vector determined by a beam forming operation. The received signals including the weight vector are provided in common to a channel estimator 230, a data detector 240, and an interference and noise estimator 250.

The interference and noise estimator 250 first sets interference and noise power to an initial value, and henceforth, measures interference and noise power using a quantized data vector provided from the quantizer 270 and a current reception signal. The channel estimator 230 calculates a spatial and temporal channel impulse response matrix and a system matrix using the interference and noise power. The data detector 240 detects data from the current reception signal using the spatial and temporal channel impulse response matrix and the interference and noise power, and the detected data is provided to a decoder (not shown) for error correction and decoding.

Referring to FIG. 5, in step 310, the data estimator 260 estimates a data vector by applying the interference and noise power provided from the interference and noise estimator 250 and the system matrix provided from the channel estimator 230, to a current reception signal. In step 320, the quantizer 270 quantizes the estimated data vector and provides the quantized data vector to the interference and noise estimator 250. The interference and noise estimator 250 calculates a noise vector using Equation (34) in step 330, and calculates a noise matrix using Equation (35) in step 340. In step 350, the interference and noise estimator 250 calculates the estimated interference power by normalizing an autocorrelation matrix of the noise matrix in accordance with Equation (36) by a predetermined value Z, and calculates the interference and noise power using the estimated interference power. The interference and noise power is used in the receiver for determining a radio channel environment and performing beam forming.

As can be understood from the foregoing description, the novel beam former performs regular spatial sampling instead of estimating DOAs needed for determining weights, and directly calculates interference power based on an estimated data vector instead of decoding a received data vector and encoding the decoded data vector, thereby simplifying the structure of the receiver and reducing power measurement delay.

While the invention has been shown and described with reference to a certain exemplary embodiments thereof, it will be understood by those skilled in the art that various changes in form and details may be made therein without departing from the spirit and scope of the invention as defined by the appended claims.

1. A noise and interference power measurement apparatus for an antenna diversity system having a plurality of antenna elements, the apparatus comprising:
a channel estimator for estimating a channel impulse response for a radio channel corresponding to a predetermined plurality of regularly spaced direction-of-arrival (DOA) values;
a data estimator for estimating received data using a received signal and a system matrix including an allocated spreading code and the channel impulse response;
a quantizer for quantizing the estimated data; and
an interference and noise calculator for calculating noise vectors at the respective antenna elements by removing from the received signal an influence of the quantized data to which the system matrix is applied, calculating an estimated noise matrix at the plurality of antenna elements, the estimated noise matrix including the noise vectors, calculating interference power by auto-correlating the estimated noise matrix, and calculating noise and interference power based on the interference power.

2. The noise and interference power measurement apparatus of claim 1, wherein the received data is estimated by
\hat{d}≈[A^{H}(I_{K}_{ₐ}\mathring{x}\tilde{R}⁻¹)A]⁻¹A^{H}(I_{K}_{ₐ}\mathring{x}\tilde{R}⁻¹)e
where A denotes the system matrix, I_{K}_{ₐ} denotes a Kₐ×Kₐ identity matrix, Kₐ denotes the number of the antenna elements, \tilde{R} denotes a predefined normalization value, and e denotes the received signal.

3. The noise and interference power measurement apparatus of claim 1, wherein each of the noise vectors is calculated by
n′=e−A\hat{d}_{q}
where e denotes the received signal, A denotes the system matrix, and \hat{d}_{q} denotes the quantized data.

4. The noise and interference power measurement apparatus of claim 3, wherein the noise matrix is expressed as
$${\hat{\underline{N}}}_{DOA} = [ \begin{matrix}{\hat{\underline{n}}}^{( 1 , 1 ) T} & {\hat{\underline{n}}}^{( 1 , 2 ) T} & … & {\hat{\underline{n}}}^{( 1 , Z ) T} \\ {\hat{\underline{n}}}^{( 2 , 1 ) T} & {\hat{\underline{n}}}^{( 2 , 2 ) T} & … & {\hat{\underline{n}}}^{( 2 , Z ) T} \\ ⋮ & ⋮ & ⋰ & ⋮ \\ {\hat{\underline{n}}}^{( {K}_{a} , 1 ) T} & {\hat{\underline{n}}}^{( {K}_{a} , 2 ) T} & … & {\hat{\underline{n}}}^{( {K}_{a} , Z ) T}\end{matrix} ]$$
where \hat{n}^{(k}^{ₐ}^{,z)} denotes a noise vector indicating a z^{th} noise at a kₐ^{th} antenna element, and Z denotes a value previously selected such that it is less than the number of data symbols constituting the estimated data.

5. The noise and interference power measurement apparatus of claim 4, wherein the interference power is calculated by
$$\begin{matrix}{\hat{\underline{R}}}_{DOA} = \frac{1}{Z} {\hat{\underline{N}}}_{DOA} {\hat{\underline{N}}}_{DOA}^{H} \\ = \frac{1}{Z} [ \begin{matrix}{\sum }_{z = 1}^{Z} {‖ {\hat{\underline{n}}}^{( 1 , z )} ‖}^{2} & {\sum }_{z = 1}^{Z} {\hat{\underline{n}}}^{( 1 , z ) H} {\hat{\underline{n}}}^{( 2 , z )} & … & {\sum }_{z = 1}^{Z} {\hat{\underline{n}}}^{( 1 , z ) H} {\hat{\underline{n}}}^{( {K}_{a} , z )} \\ {( {\sum }_{z = 1}^{Z} {\hat{\underline{n}}}^{( 1 , z ) H} {\hat{\underline{n}}}^{( 2 , z )} )}^{*} & {\sum }_{z = 1}^{Z} {‖ {\hat{\underline{n}}}^{( 2 , z )} ‖}^{2} & … & {\sum }_{z = 1}^{Z} {\hat{\underline{n}}}^{( 2 , z ) H} {\hat{\underline{n}}}^{( {K}_{a} , z )} \\ ⋮ & ⋮ & ⋰ & ⋮ \\ {( {\sum }_{z = 1}^{Z} {\hat{\underline{n}}}^{( 1 , z ) H} {\hat{\underline{n}}}^{( {K}_{a} , z )} )}^{*} & {( {\sum }_{z = 1}^{Z} {\hat{\underline{n}}}^{( 2 , z ) H} {\hat{\underline{n}}}^{( {K}_{a} , z )} )}^{*} & … & {\sum }_{z = 1}^{Z} {‖ {\hat{\underline{n}}}^{( {K}_{a} , z )} ‖}^{2}\end{matrix} ]\end{matrix}$$
where \hat{R}_{DOA} denotes the interference power, \hat{N}_{DOA} denotes the noise matrix, Z denotes a value previously selected such that it is less than the number of data symbols constituting the estimated data, and \hat{n}^{(k}^{ₐ}^{,z)} denotes a noise vector indicating a z^{th} noise at a kₐ^{th} antenna element.

6. The noise and interference power measurement apparatus of claim 5, wherein the noise and interference power is calculated by
\hat{R}ₙ=\hat{R}_{DOA}\mathring{x}\tilde{R}
where \hat{R}ₙ denotes the noise and interference power, and \tilde{R} denotes a predefined normalization value.

7. The noise and interference power measurement apparatus of claim 5, wherein the noise and interference power is calculated by
\hat{R}ₙ≈\hat{R}_{DOA}\mathring{x}I_{L}
where \hat{R}ₙ denotes the noise and interference power, I_{L} denotes an L×L identity matrix, and L denotes a predetermined number of interference signals.

8. A noise and interference power measurement method for an antenna diversity system having a plurality of antenna elements, the method comprising the steps of:
estimating a channel impulse response for a radio channel corresponding to a predetermined plurality of regularly spaced direction-of-arrival (DOA) values;
estimating received data using a received signal and a system matrix including an allocated spreading code and the channel impulse response;
quantizing the estimated data;
calculating noise vectors at the respective antenna elements by removing from the received signal an influence of the quantized data to which the system matrix is applied;
calculating an estimated noise matrix at the plurality of antenna elements, the estimated noise matrix including the noise vectors, and calculating interference power by auto-correlating the estimated noise matrix; and
calculating noise and interference power based on the interference power.

9. The noise and interference power measurement method of claim 8, wherein the received data is estimated by
\hat{d}≈[A^{H}(I_{K}_{ₐ}\mathring{x}\tilde{R}⁻¹)A]⁻¹A^{H}(I_{K}_{ₐ}\mathring{x}\tilde{R}⁻¹)e
where A denotes the system matrix, I_{K}_{ₐ} denotes a Kₐ×Kₐ identity matrix, Kₐ denotes the number of the antenna elements, \tilde{R} denotes a predefined normalization value, and e denotes the received signal.

10. The noise and interference power measurement method of claim 8, wherein each of the noise vectors is calculated by
n′=e−A\hat{d}_{q}
where e denotes the received signal, A denotes the system matrix, and \hat{d}_{q} denotes the quantized data.

11. The noise and interference power measurement method of claim 10, wherein the noise matrix is expressed as
$${\hat{\underline{N}}}_{DOA} = [ \begin{matrix}{\hat{\underline{n}}}^{( 1 , 1 ) T} & {\hat{\underline{n}}}^{( 1 , 2 ) T} & … & {\hat{\underline{n}}}^{( 1 , Z ) T} \\ {\hat{\underline{n}}}^{( 2 , 1 ) T} & {\hat{\underline{n}}}^{( 2 , 2 ) T} & … & {\hat{\underline{n}}}^{( 2 , Z ) T} \\ ⋮ & ⋮ & ⋰ & ⋮ \\ {\hat{\underline{n}}}^{( {K}_{a} , 1 ) T} & {\hat{\underline{n}}}^{( {K}_{a} , 2 ) T} & … & {\hat{\underline{n}}}^{( {K}_{a} , Z ) T}\end{matrix} ]$$
where \hat{n}^{(k}^{ₐ}^{,z)} denotes a noise vector indicating a z^{th} noise at a kₐ^{th} antenna element, and Z denotes a value previously selected such that it is less than the number of data symbols constituting the estimated data.

12. The noise and interference power measurement method of claim 11, wherein the interference power is calculated by
$$\begin{matrix}{\hat{\underline{R}}}_{DOA} = \frac{1}{Z} {\hat{\underline{N}}}_{DOA} {\hat{\underline{N}}}_{DOA}^{H} \\ = \frac{1}{Z} [ \begin{matrix}{\sum }_{z = 1}^{Z} {‖ {\hat{\underline{n}}}^{( 1 , z )} ‖}^{2} & {\sum }_{z = 1}^{Z} {\hat{\underline{n}}}^{( 1 , z ) H} {\hat{\underline{n}}}^{( 2 , z )} & … & {\sum }_{z = 1}^{Z} {\hat{\underline{n}}}^{( 1 , z ) H} {\hat{\underline{n}}}^{( {K}_{a} , z )} \\ {( {\sum }_{z = 1}^{Z} {\hat{\underline{n}}}^{( 1 , z ) H} {\hat{\underline{n}}}^{( 2 , z )} )}^{*} & {\sum }_{z = 1}^{Z} {‖ {\hat{\underline{n}}}^{( 2 , z )} ‖}^{2} & … & {\sum }_{z = 1}^{Z} {\hat{\underline{n}}}^{( 2 , z ) H} {\hat{\underline{n}}}^{( {K}_{a} , z )} \\ ⋮ & ⋮ & ⋰ & ⋮ \\ {( {\sum }_{z = 1}^{Z} {\hat{\underline{n}}}^{( 1 , z ) H} {\hat{\underline{n}}}^{( {K}_{a} , z )} )}^{*} & {( {\sum }_{z = 1}^{Z} {\hat{\underline{n}}}^{( 2 , z ) H} {\hat{\underline{n}}}^{( {K}_{a} , z )} )}^{*} & … & {\sum }_{z = 1}^{Z} {‖ {\hat{\underline{n}}}^{( {K}_{a} , z )} ‖}^{2}\end{matrix} ]\end{matrix}$$
where \hat{R}_{DOA} denotes the interference power, \hat{N}_{DOA} denotes the noise matrix, Z denotes a value previously selected such that it is less than the number of data symbols constituting the estimated data, and \hat{n}^{(k}^{ₐ}^{,z)} denotes a noise vector indicating a z^{th} noise at a kₐ^{th} antenna element.

13. The noise and interference power measurement method of claim 12, wherein the noise and interference power is calculated by
\hat{R}ₙ=\hat{R}_{DOA}\mathring{x}\tilde{R}
where \hat{R}ₙ denotes the noise and interference power, and \tilde{R} denotes a predefined normalization value.

14. The noise and interference power measurement method of claim 12, wherein the noise and interference power is calculated by
\hat{R}ₙ≈\hat{R}_{DOA}\mathring{x}I_{L}
where \hat{R}ₙ denotes the noise and interference power, I_{L} denotes an L×L identity matrix, and L denotes a predetermined number of interference signals.
